(19) United States
(12) Patent Application Publication
(10) Pub. No.: US 2011/0166897 A1
(43) Pub. Date: Jul. 7, 2011

(54) PARKING SYSTEM AND METHOD OF EMPLOYING SAME

(76) Inventor: Hope Beckman, Concord, MA (US)

(21) Appl. No.: 12/834,482

(22) Filed: Jul. 12, 2010

Related U.S. Application Data
(60) Provisional application No. 61/266,028, filed on Dec. 2, 2009.
(60) Provisional application No. 61/224,758, filed on Jul. 10, 2009.

(51) Int. Cl. G06Q 10/00

(52) U.S. Cl. 705/5

(57) ABSTRACT

The present invention is directed to a system and method for pairing lessors and lessees of parking spaces and generating a profit from each transaction. The system and method are employed over computing means and includes an option for charging a municipality an administrative fee for establishing the system within the municipality.

### RELATED APPLICATIONS

The present application claims priority to U.S. Provisional Application No. 61/224,758 filed on Jul. 10, 2009, the entire content of which is incorporated by reference and U.S. Provisional Application No. 61/266,028 filed on Dec. 2, 2009, the entire content of which is incorporated by reference.

### BACKGROUND

1. Field of the Invention

The present invention relates generally to parking systems and more particularly to an interactive computer-implemented system and method for leasing parking spaces to requesting parties.

2. Discussion of Background Information

Currently, parking in population-dense metropolitan areas is difficult and expensive. For example, Boston is a relatively small city with limited parking and high prices associated with available public parking. Boston ranks second in the US for daily and monthly parking rates, at $33/day and $460/mo. (median prices). Affordable, dynamic parking options would generate enormous interest for both lessors and lessees by creating efficiencies in the parking marketplace. Parking is a necessity item which drivers pay for using discretionary funds. Therefore a need exists for a service requiring no additional spending and which would save drivers money. Currently in Boston, a driver who parks in garage for more than two and a half hours pays on average between $32 and $36 for that duration. A need exists for a system that lessens this burden and generates income on behalf of individual space owners, event parkers, municipalities and management companies who are subject to the market's current inefficiencies.

For example, if one were to go to a hair appointment on Newbury St., Boston, for a period of two and a half hours, available parking choices would include parking in a lot for $32 or parking in the Nike™ Town garage for $36. What is needed is a service that makes use of available spaces which may be unavailable to the public otherwise and charges a fee that is more aligned with the duration of parking. For example, what is needed is a service that enables a driver to rent an available space (e.g. private or municipal) for a fixed rate and time while generating revenue for the space owner. In the present case, for example, what is needed is an option to rent a space in an alley behind Newbury St., for example, for 3 hours at a rate of $5.00/hr. for a total cost of $15.00. This would create revenue for the space owner and provide a driver with an option of paying a fee more appropriate for the service rendered, i.e. the leasing of a parking space for a relatively short duration.

### SUMMARY OF THE INVENTION

The present invention solves the problems associated with parking in population dense areas and provides a reliable, easily employed system and method for pairing lessees with lessors of parking spaces otherwise unavailable to the public at large or available only for high fees. The system and method provide a public and widely accessible interface for pairing drivers with leased parking spaces registered with the system. For a fee, a driver may lease a uniquely identified parking space for a discreet, pre-selected period of time.

In one embodiment, the present invention provides a computer implemented method for pairing a vehicle with a uniquely identified registered parking space in response to a request being sent from a user terminal communicating with an organization terminal over a network. In one embodiment, method comprises providing an organization terminal connected to the network, wherein the organization terminal comprises a memory portion and a processor portion, the memory portion comprises a registry of one or more parking spaces available for lease and one or more associated schedules of occupancy, and the memory portion contains therein a software portion executable by the processor for instructing the organization terminal to pair a vehicle with an available, uniquely identified registered parking space in response to a request to lease a registered parking space for a defined period of time.

The embodiment further comprises presenting a registration portal on a graphic display of the user terminal, the registration portal comprising one or more input fields and/or selection menus for placing a request based on a desired parking location and a time period during which parking is desired and/or parking space price range. In response to receiving the request from the user terminal at the organization terminal the organization terminal identifies one or more available registered parking spaces mostly closely satisfying the request criteria and displays the one or more available registered parking spaces on a graphic display at the user terminal. Upon receiving a parking space selection from the user terminal, the organization terminal provides the user terminal with a unique identifier associated with the selected parking space and associated reserved time period.

In another embodiment, the present invention comprises a system for pairing requests for parking spaces with registered spaces available for lease for a fee and for a specified time period. In one embodiment, the system comprises an interactive interface hosted by at least one computer that is in communication with a computer network, wherein the interactive interface is accessible by a user terminal that is also in communication with the computer network. In one embodiment, the system further comprises a server connected to the at least one computer, wherein the server stores a database containing availability information, pricing information and geographic location information associated with one or more registered parking spaces available for leasing through the interactive interface. Executable software is adapted for running on the at least one host computer wherein the executable code instructs the computer to provide the interactive interface at a user terminal also in communication with the computer network, the interactive interface containing one or more selection means for placing a request to park a vehicle having unique identification characteristics in a geographic location during a specified period of time.

In one embodiment, the at least one computer receives a request comprising one or more parking space characteristics defined by the one or more selection means, and the executable code commands the at least one computer to identify at least one registered parking space that matches the one or more parking space characteristics specified in the request. The at least one computer receives an affirmative selection of an available registered parking space from the user terminal and payment for lease of the selected registered parking space for the specified period of time, and the executable code commands the at least one host computer to record one or more unique vehicle identification characteristics associated with the selected registered parking space. In response to receiving payment, the at least one computer forwards a unique identifier associated with the selected registered parking space to the user terminal. A user may then use the unique identifier to park in the purchased space for an indicated time frame.

### BRIEF DESCRIPTION OF THE DRAWINGS

One will better understand these and other features, aspects, and advantages of the present invention following a review of the description, appended claims, and accompanying drawings in which:

FIG. 1 depicts one embodiment of the system of the present invention.

FIG. 2 depicts a portion of one embodiment of the system of the present invention.

FIG. 3 depicts a portion of one embodiment of the system of the present invention.

FIG. 4A depicts a portion of one embodiment of the system of the present invention.

FIG. 4B depicts a portion of one embodiment of the system of the present invention.

FIG. 5 depicts a portion of one embodiment of the system of the present invention.

FIG. 6 depicts a portion of one embodiment of the system of the present invention.

FIG. 7 depicts a portion of one embodiment of the system of the present invention.

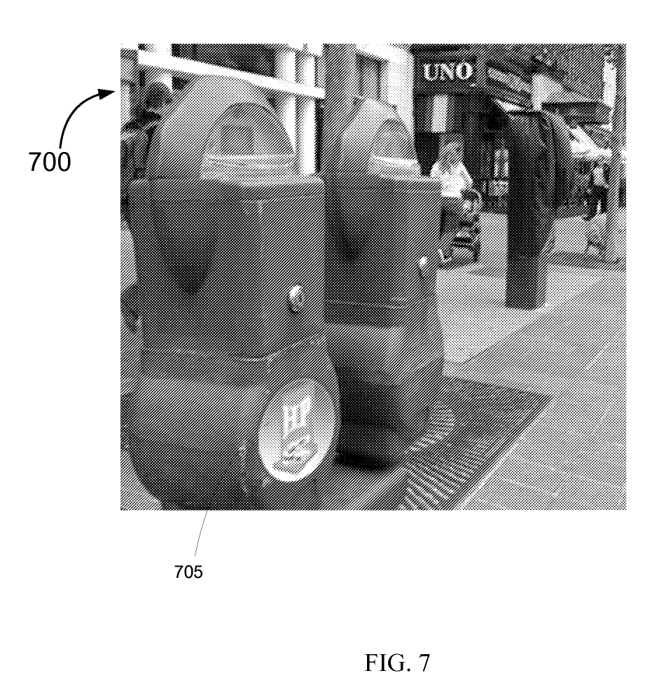

FIG. 8 depicts a portion of one embodiment of the system of the present invention.

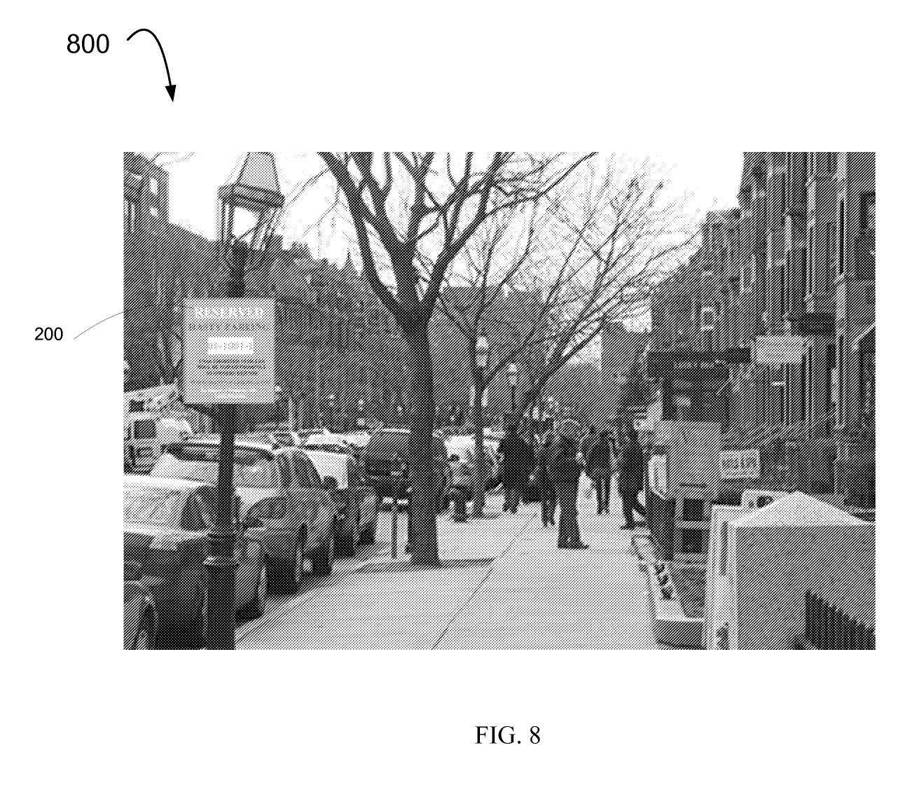

### DETAILED DESCRIPTION

The present invention solves problems associated with parking in population dense areas and provides a reliable, easily employed system and method for pairing lessees with lessors of parking spaces otherwise unavailable to the public. Embodiments of the invention permit lessees to reserve a parking space by pre-payment via credit card or ACH funds transfer, for example. The system and method provide a public and widely accessible interface for pairing drivers with leased parking spaces registered with the system. For a fee, a driver may lease a uniquely identified parking space for a discreet and selectable period of time. In this description, the terms “driver”, “lessee”, and “user” are used interchangeably to reference the consumers of this system and method, and the terms “owner” and “lessor” are used interchangeably to reference the owner of a parking space available for lease.

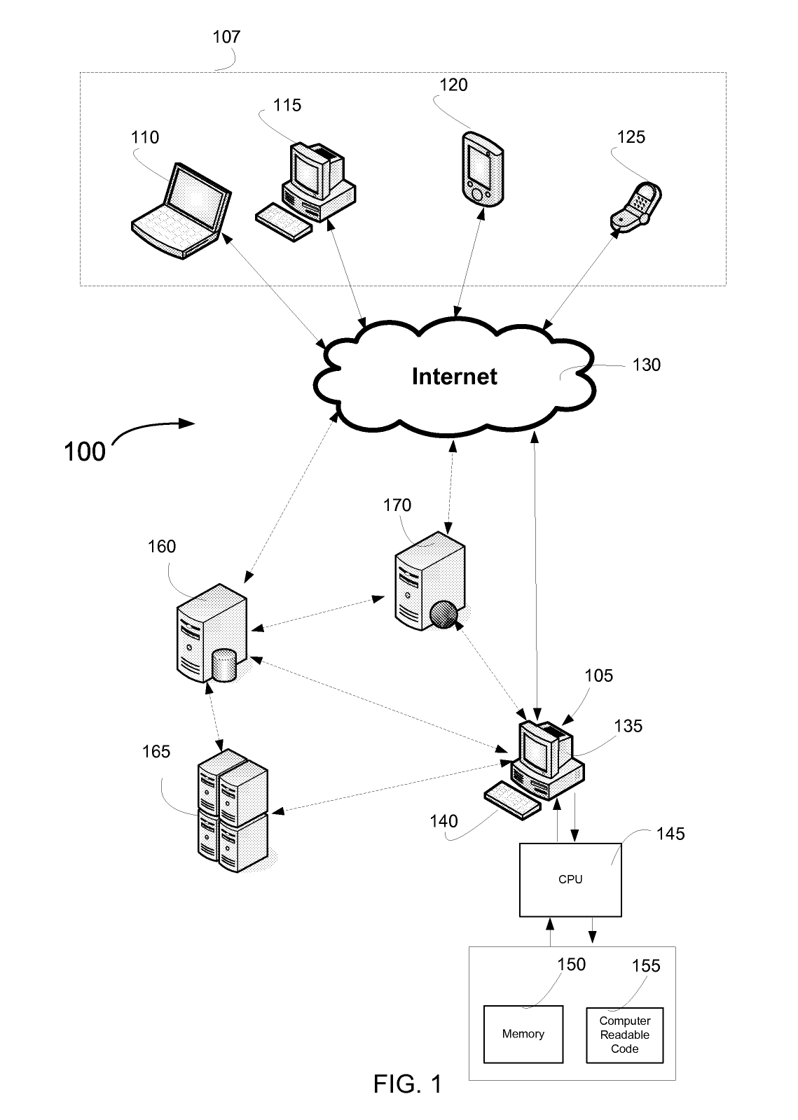

FIG. 1 depicts an overview of an embodiment of the system 100 of the present invention. This system 100 includes an organization terminal 105 in communication with a plurality of user terminals 107 that are communicating through a computer network. Because the present invention is available on a global level, and because the Internet 130 is a global electronic communications network linking private and public networks and computers, the Internet 130 is an appropriate medium for facilitating the present invention. The plurality of user terminals 107 are preferably devices capable of communicating with the Internet 130 through wired or wireless means, devices for example such as a laptop computer 110, a stationary computer 115, a personal computing device (PCD) 120, and a cellular telephone 125.

The organization terminal 105 is preferably a computer that comprises elements typical of a computing system maintained by the owner of the system 100. These elements include items such as a monitor 135, a keyboard 140, a processor such as a central processing unit (CPU) 145, and a memory storage area 150. The memory storage area 150 may be random access memory (RAM), or a combination of RAM and some removable memory storage means such as floppy disk, EPROMs, PROMs, or USB storage devices. The memory storage area 150 contains computer readable code, or software 155, for executing the present invention. In an alternative embodiment, the memory storage area 150 may be a database server 160 for an added level of security and more expansive storage capacity. In an alternative embodiment, the organization terminal 105 optionally also may communicate with an application server 165 that stores and executes the software 155 and with a web server 170 that hosts an interactive website that presents information regarding space availability, and lessor and lessee registration portals.

Bi-directional routers (not shown) also may be disposed between each of the plurality of user terminals 107 and the Internet 130, and between the Internet 130 and the organization terminal 105. Additionally the laptop computer 110, stationary computer 115, PCD 120, and cellular telephone 125 are shown by way of example only and an unlimited number of user terminals 107 may communicate with the organization terminal 105.

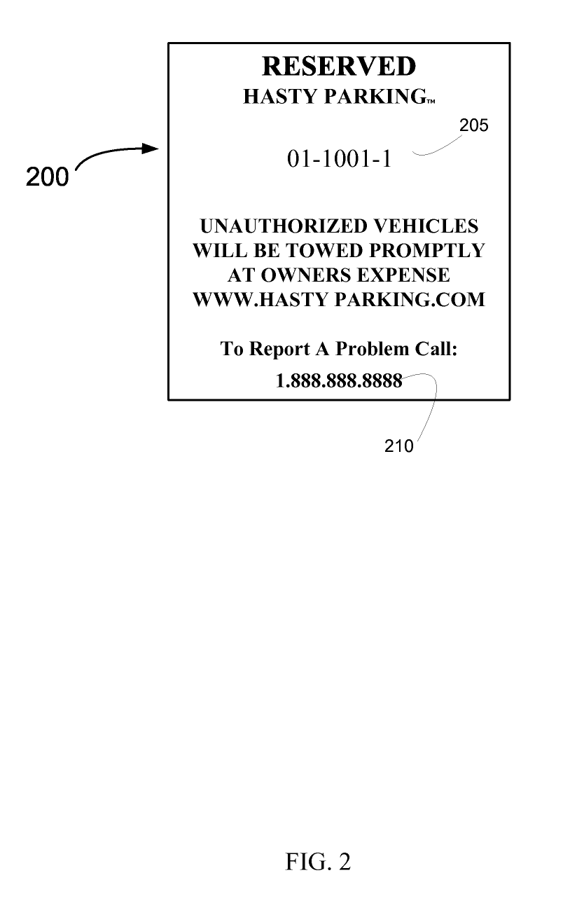

In one embodiment, as FIG. 2 depicts, each parking space registered with the system 100 will be marked with a sign 200 or free-standing parking device displaying a designated number 205 corresponding to the inventory number for that space. The system 100 and/or databases 160, 165, 170 therein store the inventory identifier, i.e. the designated number 205, and associated space location and availability information. For example, in one embodiment, if a customer performs a search for a space and enters an address into a website reservation portal 300, the website reservation portal 300 will display a Google™ map 305 displaying one or more visual indicators 310, such as green, red and yellow dots, indicating locations of parking spaces that are available, unavailable and soon to be available. In one embodiment, the map 305 may be a heat map display showing in a varying spectrum of colors the areas that are more relevant and/or provide more availability than others wither regard to the requested location. Once a customer identifies a preferred parking location and clicks on the associated visual indicator 310, the space details 312, including, for example, inventory number, street address, availability type (hourly, daily, weekly and/or monthly), and cost will appear in a highlighted box on the display at the user terminal 107. The user may enter into form fillable fields and/or drop down fields 315 a plurality of information including, for example, specific reservation criteria, agreement to the terms of the rental, vehicle identification information (year, make, model, plate number & state) and electronic payment means, such as a credit card or bank account routing number, provided for completing the transaction of renting a selected space using.

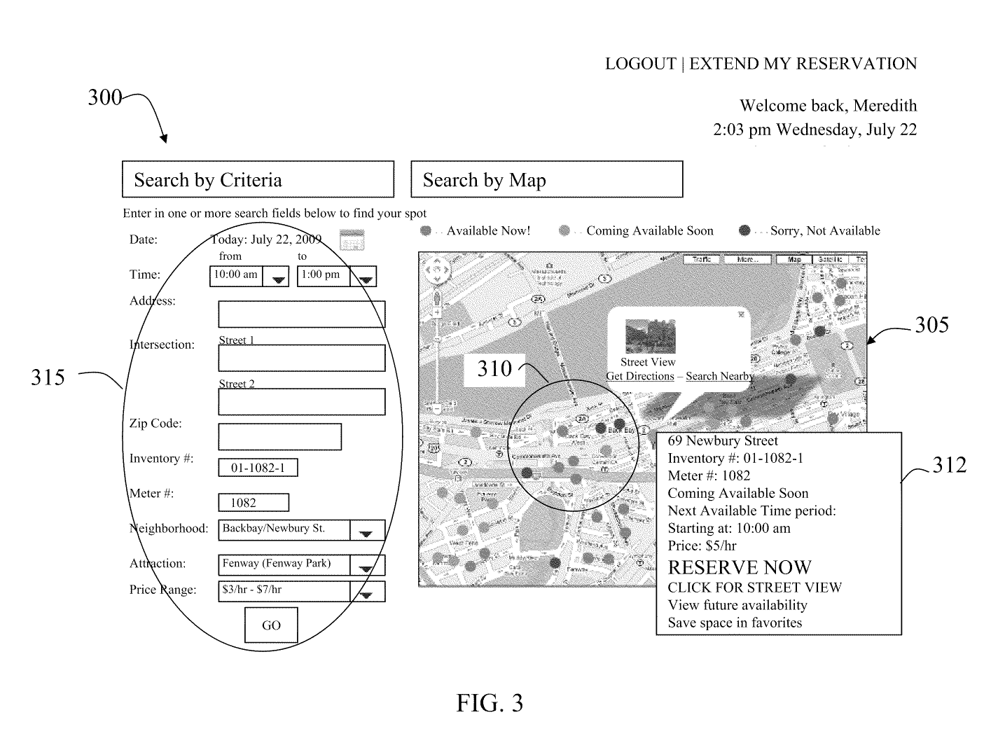

Once the users selects a space available during the requested period of rental and submits payment, the user then will have secured a reservation through the website reservation portal 300. In one embodiment, the web server 170, hosts a unique online website reservation portal, 300 “Hasty Parking™”, for pairing parking space lessors with lessees via a website displayable on a user terminal 107. For example, as show in FIG. 3, the reservation portal 300 will offer an online mapping interface, such as Google™ Maps, so that lessees may perform searches for spaces using either a specific address, cross streets(s), zip code search or inventory number if a specific space identifier is already known. (In one embodiment, each space registered with the system 100 has a uniquely assigned space identifier, which may be a number visibly displayed at the space or an electronically transmitted code interpreted by a mobile receiver, such as an RFID receiver, placed within the vehicle.) Additionally, a user may enter information into a plurality of form fillable fields and/or drop down fields 315 and search for a space by availability on a specific day and/or at a specific time (e.g. 6:00 pm, Jun. 30, 2009, Newbury & Dartmouth St., Boston).

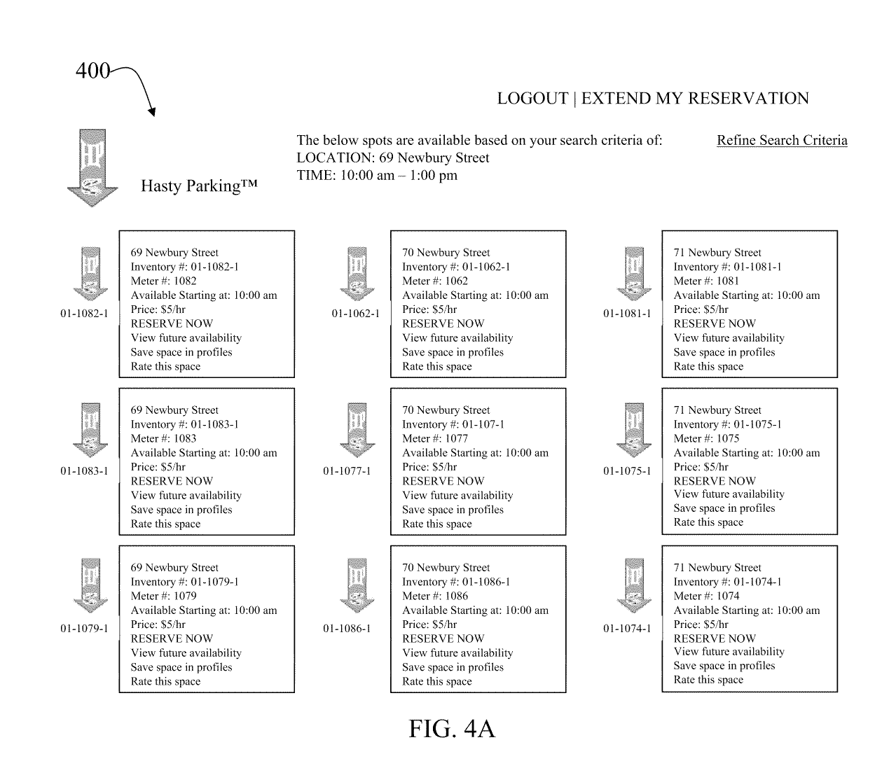

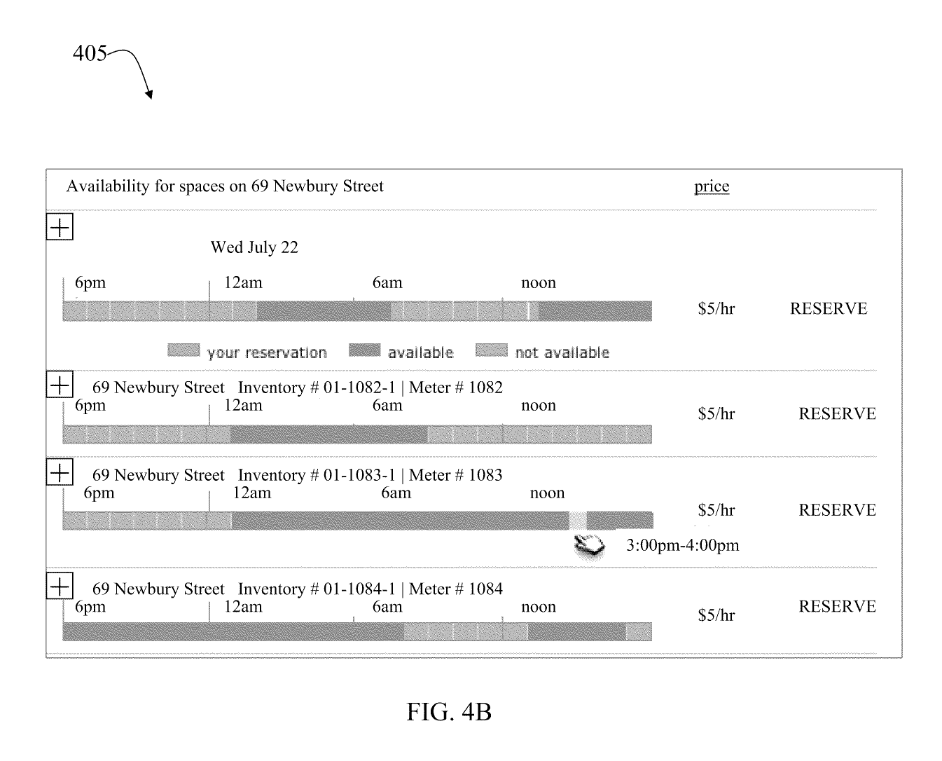

In one embodiment, the website reservation portal 300 also will offer a commerce feature allowing users to pay for transactions in advance via the website reservation portal 300 displayed on either a computer 110, 115 or mobile device 120, 125. Additionally, the system 100 will maintain an online inventory of available, unavailable and soon-to-be available spaces and will display this inventory on the reservation portal 300 as depicted, for example, in inventory display 400 of FIG. 4A and the availability and reservation calendar 405 of FIG. 4B. In one embodiment, the availability and reservation calendar 405 maybe color coded and/or incrementally shaded to indicate blocks of time that are available for renting a space and blocks of time during which a space is already rented. Because the present invention enables pre-reservation of a space in a particular location and for a particular duration, in another embodiment, the system 100 enables users to bid on available spaces, with the highest bidder purchasing the parking space rental. The system 100 therefore enables another unique, equitable solution for pricing a rental space in accordance with demand and user estimation of rental space worth for the specified duration.

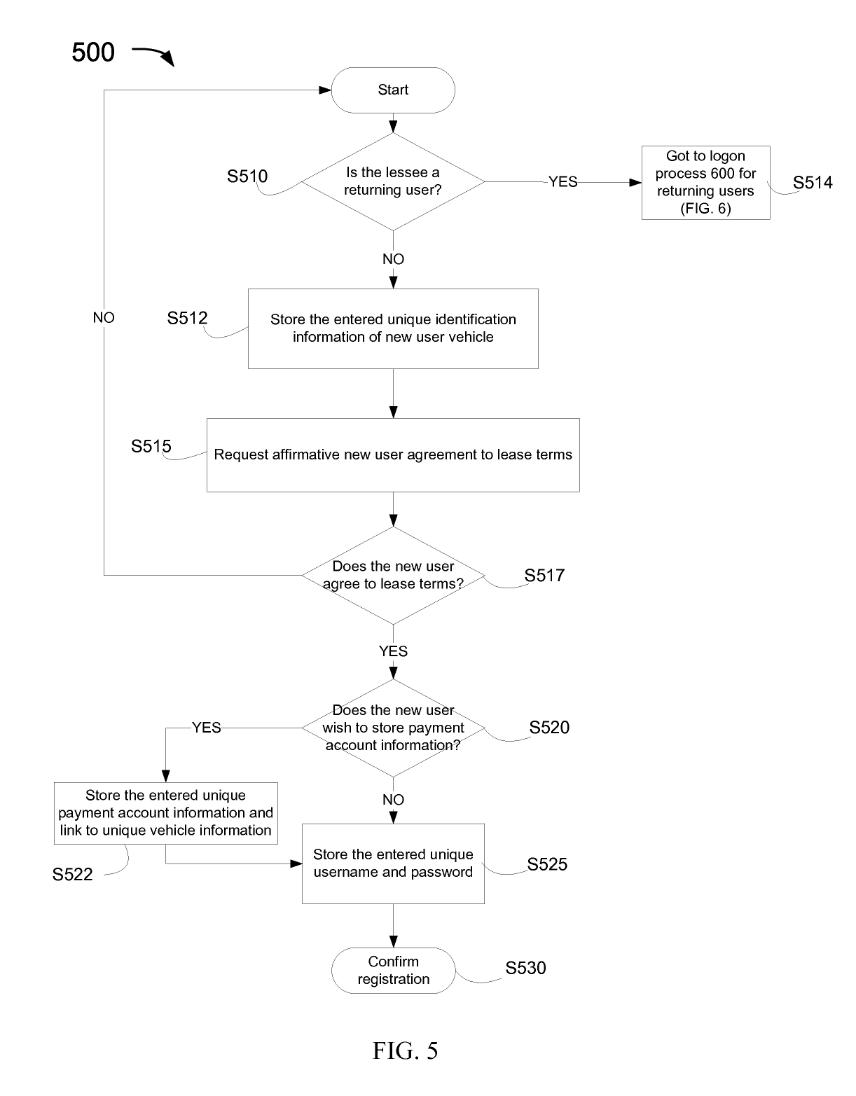

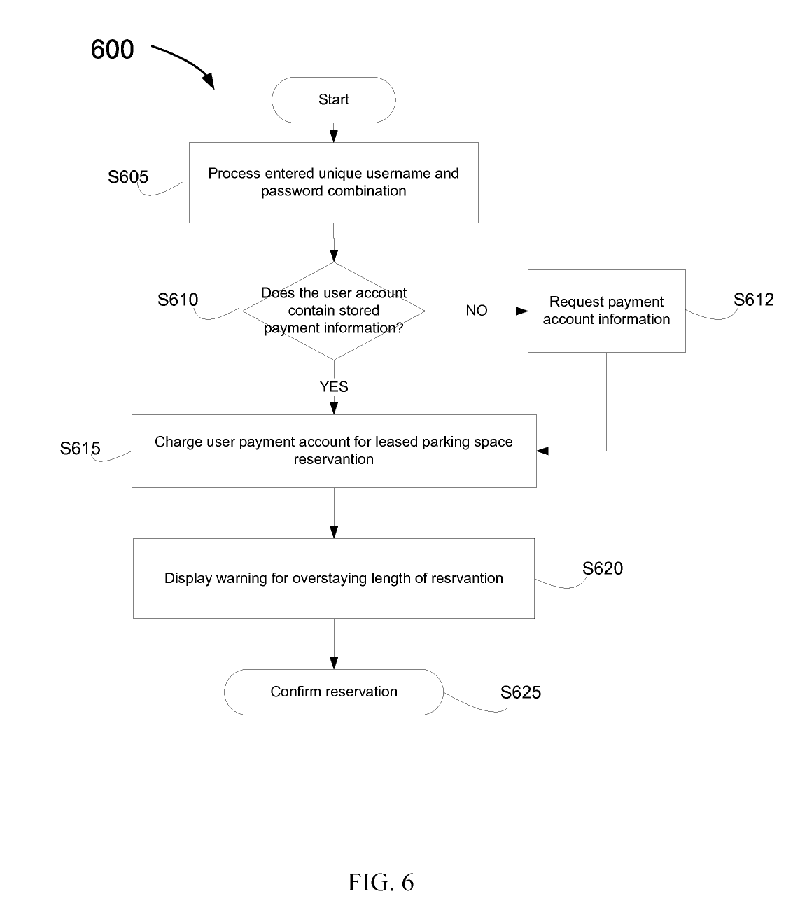

Turning now to user/lessee registration with the system, in one embodiment, the system 100 requires a user to enter unique identification information which will be stored along with valid payment information, such as credit card information, for retrieving payment of fees and/or penalties. As indicated in one embodiment of the registration method 500 depicted in FIG. 5, first time users are required to register with the system 100 by entering such identifying information. For example, in one embodiment of the method of registration, the system 100 will store unique vehicle information in one step S512 and optionally will store entered payment information in another step S522 for later automatic retrieval within the system 100. According to the embodiment of FIG. 5, registering with the system also comprises a step of creating a unique username and password S525 for use with later logons to the system 100. As indicated in the flow chart of FIG. 6, returning users will be able to logon in a typical fashion, by entering a unique logon name and password S605 that may either be linked to stored payment information (e.g. credit card account, bank account, etc.) or updated S612 with new, non-stored payment information.

In one embodiment, after an initial registration, the user will receive a sticker generated by the system 100 and delivered to a registered postal address. By affixing the sticker to a registered vehicle in a visible location, such as the back bumper or windshield, a user readily identifies a vehicle as being registered with the system 100. In this embodiment, a unique participant code located on the sticker allows select personnel, such as meter maids, to identify users and retrieve reservation information. This embodiment also enables meter maids to issue electronic tickets more easily. The user may park at a registered metered space 700 bearing system identification 705 or a non-metered, appropriately identified registered space 800 represented by a system-identifying sign 200. The present invention does not require a meter to pair lessees with registered parking spaces available for lease. The system 100 therefore requires no maintenance costs and no administration costs associated with electronic and mechanical meter machine usage. Basic visual cues enable uncomplicated, easily-administered leasing. Beyond initial registration, no consumables, such as electricity, are required to practice the current invention which makes the present invention extremely environmentally friendly. In some embodiments, physical registration maybe possible at a designated municipality location, for example, thereby eliminating any consumables and proving a truly low impact or no-environmental impact, environmentally-friendly option for administering the system 100.

In one embodiment, the website reservation portal 300 also will allow users to logon during their reservation period and extend their reservation, if needed, pending availability. The system 100 even may send an alert to a portable device registered with the system 100 during initial user registration. In one embodiment the alert message indicates that a reservation is about to expire and requests whether the user wishes to extend the reservation period for fee in that registered space or in a nearby available or soon-to-be-available space. In one embodiment, the system 100 may prove the user device 107 with a hyperlink selection icon or hyperlink text for immediately submitting a request for extension and/or redirecting to a reservation extension request page on the system website.

The system 100, however, discourages lessees from staying in a space beyond the pre-paid period because all lessees enter personal information during reservation and pay for their space rental using a credit card or routing number that may incur additional automatically applied penalty charges. As FIG. 6 indicates, a confirmation of reservation step S625 includes displaying to the user (i.e. the lessee) a warning indicating a risk of towing and/or an applicable fine for overstaying the reservation beyond a particular duration of time. For example, in one embodiment, the system 100 will retain credit card information for at least the duration of a rental period and for a subsequent period thereafter, for example 24 hours. In the event that a user overstays a reservation, the system 100 will generate an electronic “ticket” or penalty fee to the user account. For example, if a subsequent lessee of the same parking space reports the user overstaying his reservation, the system 100 may charge the lingering user/lessee a $30.00 penalty fee, half of which will credit to an account of the inconvenienced user hoping to park in the occupied space, and half of which will credit to the owner of the system 100 to cover administrative costs associated with relocating the inconvenienced user.

In one embodiment, when encountering a lingering user, the inconvenienced user may call a phone number 210 which will appear on every sign/space marker 200, and a live operator will answer the phone call and perform an availability check for a conveniently located, available leased space. The original reservation will transfer to the next closest and available space based on the originally inputted reservation criteria, and the system 100 will apply a credit, for example $15.00, to the parking account that the inconvenienced user established with the system 100 during initial reservation. To receive the credit, however, in one embodiment, the inconvenienced user must verify identifying information such as but not limited to the license plate number, color, make and/or model of vehicle belonging to the lingering driver. In one embodiment, a user may execute this verification process via the system website and/or reservation portal 300 specifically, and in another embodiment, a user may telephone a system operator and verbally communicate the identification information. If the inconvenienced user correctly identifies the vehicle belonging to the previous lessee, a fine is charged to the lingering user and the inconvenienced user receives a credit. Each lessee agrees to this penalty when making a reservation. In another embodiment, the lessee is at risk of being towed when lingering beyond the reservation for a predetermined grace period.

In another embodiment, the transportation department of a municipality, such as the City of Boston, could manage the allocation of spaces via meter maids using mobile devices capable of linking to the website of the system 100. In one embodiment, for example, fines for designated reserved city parking spaces would be $45, a portion of which, e.g. $30, would be payable to the city (so as not to cut into their parking ticket revenue) and the remaining portion of which, e.g. $15, would be payable to the inconvenienced user unable to park in the reserved space.

In another embodiment, the system 100 will allow tow-companies administrative access to the system 100 and databases therein for the purpose of identifying soon-to-expire reservations. If one leases a space from 1 pm to 2 pm and stays until 2:15 pm, a penalty fee will apply until 2:15 pm, after which time the current occupant will be in jeopardy of having his vehicle towed should a subsequent lessee of that space report the lingering user to the system 100. If the lessor of the space can see the space and is intending to park a car in there, the lessor could contact the system 100 and request towing of the lingering vehicle. In this embodiment, tow companies will not be authorized to tow until after the 15 minute “buffer” has expired. In this embodiment, messages will be displayed in the form of “warnings” at the time of reservation confirmation on the reservation portal 300 of the website system. Users registering with the system 100 must agree to these terms and acknowledge having read and understood the warnings in advance of renting a space.

In addition to paying penalty fees, lessees may be eligible for refunds. For example, conditions for refund may be related to natural disasters, snow emergencies resulting in road closings, water main breaks, etc.

Turning now to the process of registering spaces for lease, private party lessors must register with the system 100 in order to use the reservation portal 300 to lease their spaces. In one embodiment, lessor membership consists of establishing a log-on identity and filling out an open-ended lease agreement and agreeing to the terms and conditions of site use prior to performing any transactions on the system 100. In one embodiment, such an agreement comprises specifying the address of the space for rent, affirmatively asserting valid ownership of the space indicated and agreeing to the terms of membership, which include assuring availability of the space as posted on the system website, etc. In one embodiment, at the time of registration, lessors agree to place a credit-card, or other payment account information, on file and pay a refundable deposit fee for either a parking sign 200 or other non-electronic or electronic device or marker to unmistakable mark each registered space. This deposit fee will be refunded in-full if and when a lessor withdraws from the system 100 and returns either the sign 200 or device/marker to the owner of the system 100 in good, usable condition. In another embodiment, the sign 200 may be purchased outright for permanent use with or without an option for refund upon return.

Once a lessor registers with the system 100 by filling-out the required agreements, placing a valid credit card or other payment account information on file and paying a space-marker fee, the system 100 will prompt delivery of a sign 200 or parking device/marker to the lessor's address. The lessor must display the sign 200 or device at the leased space to make the space available through the system 100 for rentals. The designated space number 205 associated with the sign 200 or device is a necessary component of the leasing process. Once the lessor has completed the registration process, he/she may log onto the website hosting the reservation portal 300 and lease the space for selectable, discreet periods of time (e.g. hourly, daily, weekly, monthly or yearly). For example, in one embodiment, the lessor may list their space as available for a minimum of one week and for a maximum of one year before re-registering is required. The lessor is responsible for setting the price for their rental, as well as adjusting rental availability in the event that the lessor wishes to remove the space from the system 100.

In one embodiment, the system 100 maintains four unique customer profiles, i.e. profiles of lessors: (1) private space owners, (2) management companies, (3) event parking entities, and (4) public/municipalities (towns, cities). Interactions between private space owners and the system 100 are described above in the preceding description. Management companies can list their properties' available parking spaces on the website reservation portal 300. Event parking entities (e.g. parking lot owners pre-selling reserve spaces for games, events, etc.) also can list their parking spaces for reservation purposes. Municipalities, cities and towns, may sell “reserved” spaces by allocating desirable spaces at $5.00 an hour, for example, instead of at the typical metered space rate of $1.00 an hour.

As previously stated, the owner of the space, the lessor, is responsible for accessing the system 100 to maintain a calendar of availability associated with the registered space(s). In one embodiment, spaces may be listed in advance and for a maximum duration of reservation. For example, a space may be registered one month in advance of availability for leasing to a user for up to one month of parking. The system 100 will automatically update space-availability when a space is listed in active status on the website. The system 100 will update reservations and space availability during the “active period” established by the lessor of the space at the time of listing the parking space for rent. For example, if a lessor registers a space for rent and indicates that the space will be available for one week, the system will automatically indicate that space as “reserved” at the end of that week. During the “active listing” period of one week, however, the system 100 will maintain the reservation status and update availability of the space during rental and non rental periods.

In one embodiment, lessors are responsible for setting the rates associated with their spaces. For example, if a space is available hourly, the owner of the space is responsible for determining, displaying and adjusting the hourly cost of that space while active with the system 100 and displayed on the website registration portal 300. If space availability comprises a daily, weekly or monthly rental period, the owner is responsible for setting the price through the system 100 for display to potential lessees.

In one embodiment, the system 100 generates monthly reports deliverable to space owners for a fee. The reports may comprise statistical data, such as but not limited to vacancy rates, average prices paid on an hourly, daily, weekly, monthly and yearly basis for a space or spaces registered with the system 100. This will allow space-owners to adjust their pricing and availability of spaces accordingly to achieve maximum value from their rentals.

The owner of the system 100 may generate revenue strictly in the form of transaction revenue. For example, in one embodiment, fees may be calculated at a rate of 12 percent for each transaction. Exceptions may include, for example, yearly rentals and/or event parking or municipal parking. These may incur reduced charges, such as a 7.5 percent to 8.5 percent fee. When a lessee pays for a space via credit card, a credit-card affiliate will deduct a fee, for example, 2.25 percent to 3.5 percent, and deposit that amount into the system owner's account. The system owner then may deduct the remainder of the fee (up to a total of 12 percent in one embodiment), and transfer that sum via ACH credit into the space-owners' designated checking account. In one embodiment, the entire funds-transfer process from lessee to lessor is guaranteed within a prompt time, for example within a 7-business-day timeframe. In embodiments, the guaranteed delivery timeframe may be as long as 30 days or may be some alternate mutually acceptable timeframe agreed upon between the contracting parties.

In some embodiments, the owner of the system 100 and the lessor are the same entity. In one embodiment in which the owner and lessor are two distinct entities, the owner of the system 100 generates revenues based on charging the lessor (e.g. a City or any Municipality) an administrative fee. This fee covers establishing the system 100 within a locality. For example, the fee may cover charges associated with numbering spaces, converting existing administrative applications (e.g. ticketing applications), administrative training of relevant personnel, mapping streets, coding administrative applications to correspond with the lessor's established policies, etc. Fees also may cover preparing legal agreements (e.g. for lease terms) as well as regulation manuals for use by the owner of the system 100 and the lessor (e.g. a Municipality). These administrative set-up costs may be billed into the front-end of the transaction in the form of a cost to set up service of the system 100.

It is noted that the foregoing examples have been provided merely for the purpose of explanation and are in no way to be construed as limiting of the present invention. While the present invention has been described with reference to an exemplary embodiment, it is understood that the words, which have been used herein, are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

1) A computer implemented method for pairing a vehicle with a uniquely identified registered parking space in response to a request being sent from a user terminal communicating with an organization terminal over a network, the method comprising:
a) providing an organization terminal connected to the network, wherein:
i) the organization terminal comprises a memory portion and a processor portion,
ii) the memory portion comprises a registry of one or more parking spaces available for lease and one or more associated schedules of occupancy, and
iii) the memory portion contains therein a software portion executable by the processor for instructing the organization terminal to pair a vehicle with an available, uniquely identified registered parking space in response to a request to lease a registered parking space for a defined period of time;
b) presenting a registration portal on a graphic display of the user terminal, the registration portal comprising one or more input fields and/or selection menus for placing a request based on a desired parking location. time period during which parking is desired and/or parking space price range;
c) receiving the request from the user terminal at the organization terminal;
d) identifying one or more available registered parking spaces mostly closely satisfying the request criteria;
e) displaying the one or more available registered parking spaces on a graphic display at the user terminal;
f) receiving a parking space selection from the user terminal; and
g) providing the user terminal with a unique identifier associated with the selected parking space and associated reserved time period.

2) The method of claim 1 wherein the software portion is stored permanently in the memory portion.

3) The method of claim 1 wherein the memory portion is a portable storage medium connected to the organization terminal for access by the software portion.

4) The method of claim 1 wherein the memory portion is a server in communication with the organization terminal.

5) The method of claim 1, further comprising requesting one or more unique identification characteristics for identifying the vehicle associated with the request for parking in a uniquely identified registered parking space.

6) The method of claim 5 wherein the one or more unique vehicle identification characteristics are transmitted from an in-vehicle transmitter unit to a receiver disposed at the uniquely identified registered parking space.

7) The method of claim 6 wherein the transmitter intermittently and/or continuously communicates with the receiver and the receiver relays occupancy information to the organization terminal.

8) The method of claim 6 wherein the reserved time period of step 1)g) comprises a specific beginning time and end time.

9) The method of claim 8 further comprising receiving a request from a user terminal during the time period of step 1)g) for a new end time.

10) The method of claim 9 further comprising transmitting to the user terminal an acceptance or denial of extension request.

11) The method of claim 8 further comprising issuing an electronic penalty to the owner of the vehicle having the one or more unique identification characteristics when the vehicle remains in the uniquely identified registered parking space beyond the end time.

12) The method of claim 11 wherein the penalty is monetary and/or a status rating penalty associated with a particular vehicle owner.

13) The method of claim 11 wherein the penalty is monetary and/or a status rating penalty associated with a particular in-vehicle transmitter communicating with a receiver located at the uniquely identified registered space.

14) The method of claim 1 wherein the one or more registered parking spaces are owned by a private entity.

15) The method of claim 14 wherein the private entity is an individual owner.

16) The method of claim 14 wherein the private entity is a management company.

17) The method of claim 14 wherein the private entity is an event parking business.

18) The method of claim 14 further comprising issuing an electronic penalty to the private entity when a uniquely identified registered parking space is unavailable during a reserved time period.

19) The method of claim 18 wherein the penalty is monetary and/or a status rating penalty associated with the private entity.

20) The method of claim 14 wherein the private entity remotely adjusts the availability and/or price rate of the one or more registered parking space.

21) The method of claim 1 wherein the one or more registered parking spaces are owned by a public entity.

22) The method of claim 21 wherein the public entity remotely adjusts the availability and/or price rate of the one or more registered parking space.

23) The method of claim 1, further comprising prior to step 1)b) generating participation terms requiring affirmative acceptance by the vehicle owner, and storing an acknowledgement of the acceptance on the organization terminal.

24) The method of claim 23 wherein the participation terms comprise a lease agreement and/or terms and conditions summary.

25) The method of claim 1 further comprising generating a reusable unique login for a user at a user terminal.

26) The method of claim 25 further comprising storing the reusable unique login and unique information associated with the reusable unique login.

27) The method of claim 26 wherein the unique information comprises a name, an address, a credit card number, a bank account number, and/or one or more unique identifying characteristics associated with one or more vehicles.

28) The method of claim 27 further comprising prompting a user to confirm one or more unique identifying characteristics associated with the vehicle parking in the selected parking space.

29) The method of claim 1 wherein the organization terminal generates one or more reports comprising occupancy history for a uniquely identified space and pushes the one or more reports to an owner of the uniquely identified registered parking space.

30) The method of claim 1, further comprising requesting information enabling electronic transfer of funds from the user terminal to the organization terminal in exchange for providing the unique identifier associated with the selected registered parking space.

31) The method of claim 30 wherein the electronic funds transfer is linked to a credit card number entered in the registration portal at the user terminal.

32) The method of claim 30 wherein the electronic funds transfer is linked to bank account routing number entered in the registration portal at the user terminal.

33) The method of claim 1 wherein the organization terminal comprises an auditory call center accessible by a telecommunication device and/or VoIP.

34) The method of claim 33 wherein the auditory call center is automated.

35) The method of claim 33 wherein the auditory call center is manned by operators.

36) The method of claim 1 wherein the parking location is a geographic area.

37) The method of claim 36 wherein the geographic area is a particular address.

38) The method of claim 1 wherein the parking location is a unique identifier associated with a particular registered parking space.

39) A system for pairing requests for parking spaces with registered spaces available for lease for a fee and for a specified time period, comprising:
a) an interactive interface hosted by at least one computer that is in communication with a computer network, wherein the interactive interface is accessible by a user terminal that is also in communication with the computer network;
b) a server connected to the at least one computer, wherein the server stores a database containing availability information, pricing information and geographic location information associated with one or more registered parking spaces available for leasing through the interactive interface;
c) executable software running on the at least one host computer wherein:
i) the executable code instructs the computer to provide the interactive interface at a user terminal also in communication with the computer network, the interactive interface containing one or more selection means for placing a request to park a vehicle having unique identification characteristics in a geographic location during a specified period of time;
ii) the at least one computer receives a request comprising one or more parking space characteristics defined by the one or more selection means;
iii) the executable code commands the at least one computer to identify at least one registered parking space that matches the one or more parking space characteristics specified in the request;
iv) the at least one computer receives an affirmative selection of an available registered parking space from the user terminal and payment for lease of the selected registered parking space for the specified period of time;
v) the executable code commands the at least one host computer to record one or more unique vehicle identification characteristics associated with the selected registered parking space; and
vi) in response to receiving payment, the at least one computer forwards a unique identifier associated with the selected registered parking space to the user terminal.

40) The system of claim 39 wherein the selection means are one or more menus and/or input fields.

41) The system of claim 40 wherein the one or more interactive menus and/or input fields are address based.

42) The system of claim 39 wherein the selection means is an interactive map.

43) The system of claim 42 wherein the interactive map further comprises selectable color coded indicators displaying one or more available, unavailable and/or soon-to-be available registered parking spaces at a particular geographic location.
